(19) United States
(12) Patent Application Publication
(10) Pub. No.: US 2024/0351836 A1
(43) Pub. Date: Oct. 24, 2024

(54) SELF-DRIVING WAGON FOR A STORAGE SYSTEM WITH RETAINING DEVICE FOR CONTAINERS

(71) Applicant: stow Robotics GmbH, Großwallstadt (DE)

(72) Inventor: Matthias HEDDINGA, Krummesse (DE)

(21) Appl. No.: 18/686,020

(22) PCT Filed: Jul. 19, 2022
(86) PCT No.: PCT/DE2022/200160

§ 371 Date: Feb. 23, 2024

(30) Foreign Application Priority Data
Aug. 24, 2021 (DE) 10 2021 209 280.2

(51) Int. Cl. B66F 9/06; B65G 1/137

(52) U.S. Cl. CPC B66F 9/063; B65G 1/137

(57) ABSTRACT

A self-driving vehicle for the automatic storage and retrieval of containers in a storage rack arrangement includes a frame with a lower side and with an upper side. The vehicle at the lower side includes a first wheel set for the drive along a first axis and a second wheel set for the drive along a second axis which runs transversely to the first axis. The vehicle at the upper side has a liftable and lowerable lifting table with a support surface for carrying a base surface of a container. For preventing the respective container from slipping away, the vehicle has a holding device with holding surfaces which are adjacent to the support surface at the edge and which at least partly and at least temporarily project away from the support surface.

### CROSS REFERENCE TO RELATED APPLICATIONS

This application is a United States National Phase Application of International Application PCT/DE2022/200160, filed Jul. 19, 2022, and claims the benefit of priority under 35 U.S.C. § 119 of German Application DE 10 2021 209 280.2, filed Aug. 24, 2021, the entire contents of which are incorporated herein by reference.

### TECHNICAL FIELD

The present invention relates to a self-driving vehicle for the automatic storage and retrieval of containers in a storage rack arrangement with the features which are specified in the preamble of claim 1, as well as to a storage system with such a vehicle and with a track arrangement.

### BACKGROUND

Automatic storage systems with self-driving vehicles are known in the prior art. Such storage systems comprise several storage levels which can be reached by the vehicle by way of a lift or ramps. For example, WO2021059006A1 discloses a storage system with self-driving vehicles on tracks for the automatic storage and retrieval of containers in a storage rack arrangement, wherein the vehicle comprises a first wheel set for the drive along a first axis and a second wheel set for the drive along a second axis which extends transversely to the first axis. At least one of the first wheel set and second wheel set is movable essentially vertically between a drive position and an idling position. The vehicle comprises a support surface for supporting a base surface of a container.

The track system can comprise self-driving vehicles which receive the container to be

moved within their enveloping curve, in particular by way of driving below them and lifting them, so that no free space is necessary between containers which are stored next to one another and behind one another. Herein, it is useful for containers with smooth bases to also be fixed on the vehicle, in order to prevent a slipping or tilting away of the container in the case of an emergency stop or other influences. In WO2021059006A1, one suggests the vehicle having a centering and securing system for centering and securing a container on a support surface with at least two engagement elements which are simultaneously movable in opposite directions to one another between a neutral position and a securing position, wherein the engagement elements are configured such that they come into engagement with the container in the securing position, in order to secure the container on the support surface. This however requires comparatively complicated mechanics.

Furthermore, the containers for receiving the engagement elements need to be specially designed and adapted to the vehicle. The engagement elements cannot come into engagement in standardized containers which are already available on the market, without further ado.

Against this background, it is the object of the invention to improve a self-driving vehicle or storage system and to permit a simpler but yet effective securing of containers without having to especially adapt the containers to the vehicles.

### SUMMARY

According to the invention, this object is achieved by a self-driving vehicle with the features which are disclosed. Advantageous embodiments of the invention are specified in the subsequent description and the drawings.

A self-driving vehicle for the automatic storage and retrieval of containers in a storage

rack arrangement is put forward, wherein the vehicle comprises a frame with a lower side and with an upper side, wherein the vehicle at the lower side comprises a first wheel set for the drive along a first axis and a second wheel set for the drive along a second axis which runs transversely to the first axis, and wherein the vehicle on the upper side comprises a liftable and lowerable lifting table with a support surface for carrying a base surface of a container. For preventing the slippage of the respective container, one envisages the vehicle comprising a holding device with holding surfaces which are adjacent to the support surface at the edge and which at least partly and at least temporarily project away from the support surface.

The self-driving vehicle comprises a frame, on which the two wheel sets are arranged. The frame forms the basis of the vehicle and can be designed in different manners. It is particularly preferable for the frame to be designed as flatly as possible, so that the self-driving vehicle as a whole has a very flat shape. By way of this, it is possible to drive under a container which stands on a placement surface and to receive it by way of lifting the lifting table. The flatter the self-driving vehicle, the more space-saving is the manner in which the individual containers can be placed. The frame can furthermore comprise one or more motors for driving the wheel sets.

At least one of the first wheel set and the second wheel set can be movable essentially vertically between a drive position and an idle position. The first wheel set or the second wheel set can be moved and driven by way of a suitable control of the self-driving vehicle such that the vehicle can travel on the track arrangement in the desired direction.

The lifting table is arranged on the frame in a vertically movable manner. This means that the lifting table can be moved in a direction which runs essentially parallel to a surface normal of the support surface. The frame moreover comprises a lifting mechanism which is suitable for lifting the lifting table. Pneumatic or hydraulic actuators which by way of opening and closing valves permit a lifting or lowering of the lifting table via a lift cylinder are conceivable. However electrical or electromagnetic devices are also conceivable for this.

Containers which are placed onto the support surface can comprise a so-called stacking edge on their lower side, said stacking edge being with a shoulder and a support surface which is reduced compared to the outer contour and by way of which the containers can be stacked into one another which is to say onto one another. This however is not absolutely necessary and the self-driving vehicle can also be used for moving other containers which have no shoulder or stacking edge on their lower side.

In order to prevent the container from slipping down or tilting away from the support surface, one envisages the lifting table being provided with a continuous or interrupted edge at least on parts of the holding surface. This is provided in the form of the holding device with holding surfaces. The holding surfaces at least partly and at least temporarily project from the support surface. The stacking edge of the container and/or its lower surface contour is embraced or encompassed by the holding device, so that a slipping-down of the container relative to the vehicle is prevented. Herein, it is basically conceivable for the holding surfaces to project from the support surface in a permanent manner or be selectively brought into their holding position which projects from the holding surface. If a permanent arrangement of the holding surfaces is present, then the holding surfaces always project from the support surface and the total travel of the lifting table for receiving the container must therefore be increased by the vertical dimension of the holding surfaces. Rigidly fixed holding surfaces are disadvantageous due to the fact that a correspondingly larger space below the stored containers would need to be kept free in the storage rack for driving below the containers with the self-diving vehicle. In contrast, as is described further below, movable holding surfaces which at least temporarily are positioned for travel below the container such that they temporarily do not project vertically beyond the support surface even if the support surface is indeed located in a retracted lower position, are however advantageous.

If the self-driving vehicle travels below a container which is located on a placement surface of a storage rack, then the lifting table is to be travelled below preferably to the fullest extent, so that the holding surfaces are located below the container and preferably do not project beyond the vehicle. If the vehicle is located below the container to be received, the lifting table is extended again, so that the holding surfaces surround the container at its lower side and then secure it from sliding down.

An angle between the support surface and the respective holding surfaces could lie in a range of 120° to 165°. The respective holding surfaces therefore project from the support surface beyond the vertical by 30° to 75°. If a container is lifted by the lifting table, then an edge of the container can come into contact with a support surface. On account of the oblique arrangement of the contacted holding surface, the respective edge of the container slides in the direction of the center of the support surface. The holding device accordingly also functions as a centering device which is very simply mechanically but is effective despite this. The container can center itself due to its intrinsic weigh already on lifting or later due to travel-induced vibration. Herein, the container can be a container which is standardized in size and which does not need to be adapted to the vehicle.

At least one of the holding surfaces is preferably mounted in a movable manner and can be brought into a release position and into a holding position, wherein the at least one of the holding surfaces in the holding position projects beyond the support surface and encloses an angle with the support surface of at least 90° and at the most 180°, and wherein the at least one of the holding surfaces in the release position does not essentially project beyond the support surface. The respective holding surfaces can accordingly only be moved into a position projecting from the support surface which here is denoted as the holding position, when the container is received or in the process of being received. The angular detail relates to an arrangement of the holding surfaces which is perpendicular or set obliquely to the support surface. Of course, it is conceivable to consider the angular range of 120° to 165°.

The at least one of the holding surfaces can each comprise an outer edge and an inner edge, and the outer edge could be liftable with respect to the inner edge for assuming the holding position. The inner edge for example could be mounted in a pivotable manner, so that a movement into the holding position or into a neutral position can be achieved solely by way of moving the outer edge up or down. This solution is mechanically very simple and leads to an only small servicing requirement. The moving of the outer edge can be effected actively or passively. Whereas the active variant requires a separate actuator, with regard to the passive variant one can utilize a coupling to another movable element.

At least one of the holding surfaces could be pivotably connected to the frame at its respective inner edge. The inner edge is herewith spatially fixed and the moving of a part of the respective holding surface which is distanced to the inner edge is sufficient for pivoting the holding surface. The respective holding surface could be connected to the frame by way of one or more hinges which are distributed along the inner edge.

In a particularly advantageous embodiment, the at least one of the holding surfaces is coupled to the frame and to the lifting table in a movable manner, so that on lifting the lifting table it is moved into the holding position and on lowering the lifting table it is moved into the release position. Since the lifting table must be moved for lifting and lowering the container, the coupling of the lifting table to the respective holding surface can also be used to mechanically move the respective holding surface in a simple and effective manner.

The vehicle preferably moves the container into a high position of the lifting table, at which the respectively coupled holding surfaces are in the holding position. Alternatively to this, the holding surfaces can be movable independently of the lifting table, thus be decoupled from its movement, so that the holding surfaces can be set into the holding position even in a low position of the lifting table, in order to be able to move the containers in a secured manner in the low position of the lifting table. This can have the advantage that the center of gravity of the vehicle with the container is at a lower point on transport.

The at least one of the holding surfaces could each comprise a pivot axis which lies between the respective inner edge and the outer edge, wherein preferably the at least one of the holding surfaces is pivotably mounted with the lifting table at the pivot axis. The movement of the respective holding surface does not need to be effected directly at an outer edge. In contrast, it makes sense to reinforce a movement which is introduced into the holding surface, by way of a pivot axis which lies between the outer edge and the inner edge. The closer the pivot axis lies to the inner edge, the greater can the outer edge of the respective holding surface move given an unchanged movement of the lifting table.

The respective inner edge could be arranged on the frame by way of at least one laterally displaceable pivot bearing. Due to the coupling of two points of the respective holding surface which have a fixed distanced to one another, to a vertical movement for initiating a pivoting movement, it is necessary to permit a moving-away movement of one of the bearings. Since the frame is not moved, it makes sense to mount the pivoting bearing on the frame in a displaceable manner. For this, the frame can comprise for instance an elongate hole or a linear guide for receiving the pivot bearing. Given an extension movement of the lifting table, the respective pivot bearing can move laterally outwards, whereas given a retraction movement, the respective pivot bearing is moved laterally inwards.

Alternatively of course the at least one of the holding surfaces can also be pivotably mounted on the lifting table by way of at least one laterally displaceable pivot bearing.

It is further conceivable for at least one of the holding surfaces to be pivotable by way of a movement device which is arranged on the frame. The movement device in particular is an active movement device and can be understood as an actuator. This could be designed in an electrical, pneumatic, electromagnetic or hydraulic manner. It is conceivable for the self-driving vehicle to comprise actively movable holding surfaces as well as passively movable holding surfaces.

Preferably, holding surfaces are provided on at least two sides of the support surface which are opposite one another, wherein the support surface and the holding surfaces at least temporarily form a trough which widens to the top. The opposite side in particular can comprise a front side and a rear side in a main movement direction of the self-driving vehicle, wherein in particular oblique surfaces or ramps can be overcome in this main movement direction. Of course, it is also conceivable or meaningful to also provide three or four sides of the support surface with holding surfaces given more complex movement courses.

At least one of the holding surfaces at a region which is away from the support surface could be angularly bent or arched towards the support surface. Herewith, the holding of the containers can be improved yet further.

The invention further relates to a storage system, comprising a track arrangement with several track rail sections, vehicles according to the preceding description which are self driving on the track arrangement, for the automatic storage and retrieval of containers in a storage rack arrangement which can be coupled to the track arrangement, and containers which can be placed onto the self-driving vehicle and can be deposited in the storage rack arrangement.

The track rail sections can form a grid-like structure of track rail sections which are arranged longitudinally and transversely to one another and which are arranged above one another in several levels. The individual levels could be connected to one another by way of oblique surfaces or ramps or other inclined sections. The track arrangement could also be located on a high-bay and be designed in order to permit the travel of the track rail sections by the self-driving vehicles for reaching all compartments of the high bay, in order to deposit and receive containers there.

The storage system could further comprise keep-down devices which are arranged at least partly above inclined sections of the track rail sections, wherein a distance between the track rail section and the respective keep-down device, measured perpendicularly to the respective track rail section, exceeds a height of the respective vehicle with a container located thereon, to the extent that the respective container can tilt to the support surface by an angle of at the most 20° without hitting the respective keep-down device. This is a mechanically particularly simple possibility of preventing a container from tilting over when the self-driving vehicle is travelling on a ramp. If this is tilted slightly from the support surface by way of an abrupt travel movement on an inclined section, then the container can move away upwards with an upper edge from the support surface. A keep-down device which is contacted by the respective edge is arranged there. The tilting movement of the container is consequently restricted and the container after the abutting of the keep-down device can lie on the support surface again. The keep-down device can be formed by the lower side of a track rail section of the storage system which runs at one level higher.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a self-driving vehicle according to the prior art;

FIG. 2 is a schematic view showing a self-driving vehicle according to the prior art;

FIG. 3 is a schematic view showing an embodiment of a vehicle according to the invention;

FIG. 4 is a schematic view showing an embodiment of a vehicle according to the invention;

FIG. 5 is a schematic view showing an embodiment of a vehicle according to the

invention;

FIG. 6 is a schematic view showing an embodiment of a vehicle according to the invention;

FIGS. 7a, 7b, 7c, and 7d are partial view showing different embodiments of a vehicle according to the invention;

FIG. 8 is a schematic view showing parts of a storage system; and

FIGS. 9a and 9b are schematic views showing parts of the storage system.

### DESCRIPTION OF PREFERRED EMBODIMENTS

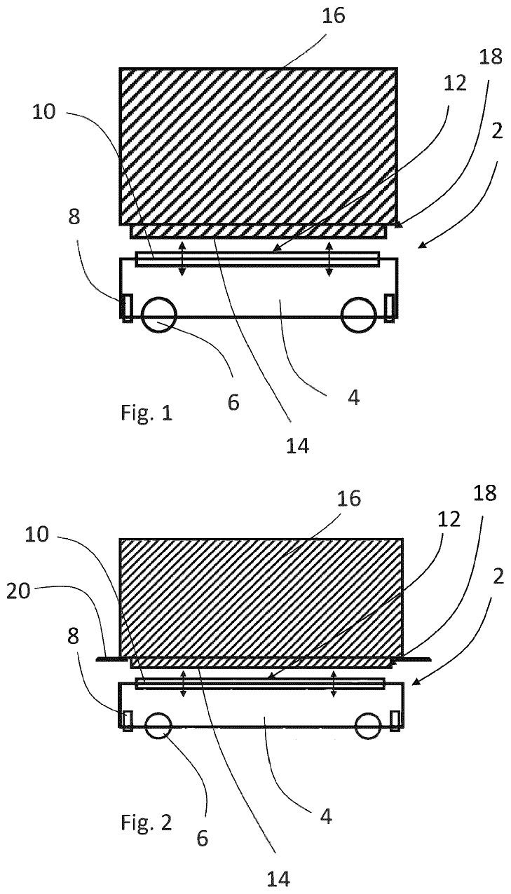

Referring to the drawings, FIG. 1 shows a self-driving vehicle 1 according to the prior art

for the automatic storage and retrieval of containers in a storage rack arrangement. The vehicle 1 comprises a frame 4 with a lower side and an upper side, wherein a first wheel set 6 for the drive along a first axis x and a second wheel set 8 for the drive along a second axis y which runs transversely to the first axis x are arranged on the lower side. A liftable and lowerable lifting table 10 with a support surface 12 for carrying the base surface 14 of a container 16 is provided on the upper side. The vehicle 1 can be driven to below the container 16, in order to receive the container 16 by way of lifting the lifting table 10. As is shown in FIG. 2, the container 16 can stand with a stacking edge 18 on a placement surface 20 of a storage rack, wherein the vehicle 1 is designed in such a flat manner that it can be driven to below the placement surface 20 given a retracted lifting table 10.

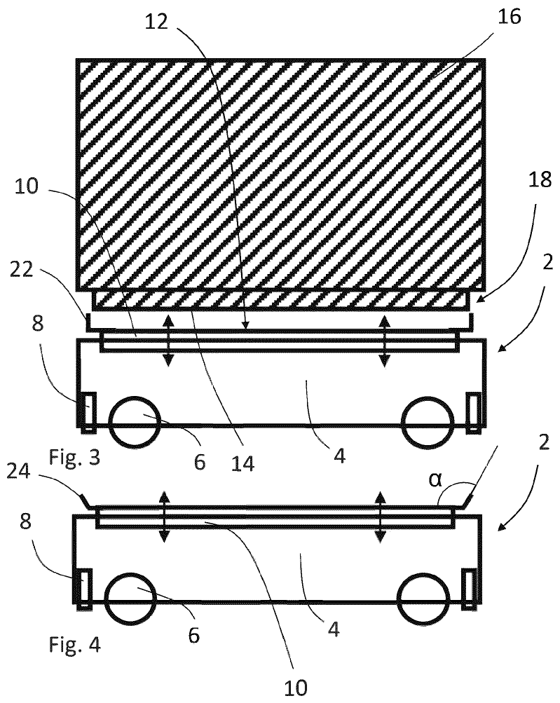

A first embodiment example of a self-driving vehicle 2 according to the invention is represented in FIG. 3, concerning which the lifting table 10 at the edge of the support surface 12 comprises holding surfaces 12 which project essentially perpendicularly to the support surface 22 and which form a holding device 24. This holding device embraces the stack edge 18 of the container 16, so that herewith the container 16 is prevented from sliding down the support surface 12. Given oblique positions on ramps or given abrupt accelerations or braking procedures, the stack edge 18 is forced upon the holding surfaces 22 and is held there.

FIG. 4 shows an embodiment example, concerning which holding surfaces 24 which run obliquely to the support surface 12 and here for example enclose an angle α of 135° with it are provided. Containers which are received by way of moving the lifting table 10 are always moved by the holding surfaces 24 in the direction of the center of the support surface 12 should the container edges contact on one of the holding surfaces 24. Herewith, a self-centering arrangement is realized without the containers having to be adapted to the vehicle for this.

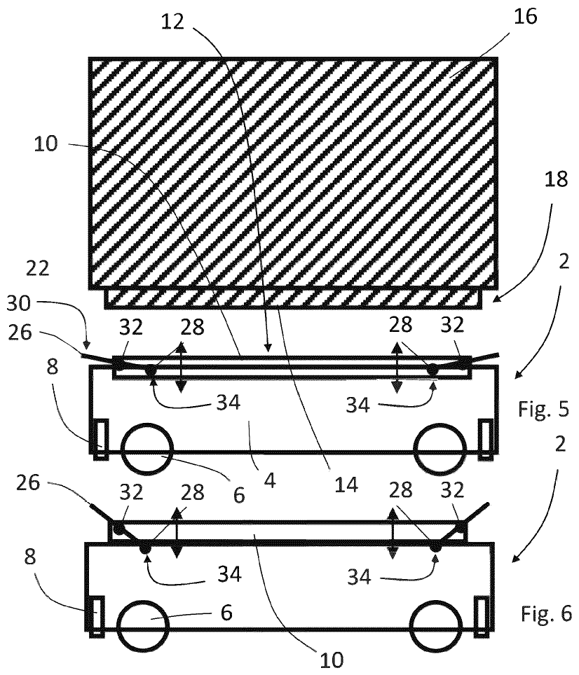

FIG. 5 shows a variant concerning which holding surfaces 26 are pivotably mounted on the vehicle 2. For this, the holding surfaces 26 each comprise an inner edge 28 which is pivotably mounted on the frame 4. A pivot axis 32 at which the respective holding surface 26 is pivotably mounted on the lifting table 10 is arranged between the inner edge 28 and an outer edge 30 of the holding surfaces 26 which is opposite to this. The inner edges 28 are mounted on the frame 4 by way of laterally displaceable pivot bearings 34, so that they can execute a compensatory movement in the lateral direction parallel to a main plane of the frame 4 when the pivot axis 32 changes its position due to the movement of the lifting table 10. By way of example, pivot bearings 36 are provided at the pivot axes 32 at a fixed position and are coupled to the lifting table 10. The fixed pivot bearings 34 follow the position of the lifting table 10 and the inner edges 28 slide laterally outwards for compensation by way of extending the lifting table 10 in the vertical direction. This can be derived from FIG. 6. In this holding position, the holding surfaces 26 set up obliquely to the support surface 12 and project beyond the support surface 12. They then assume a shape which corresponds roughly to that of FIG. 4.

On retracting the lifting table 10 downwards, the inner edges 28 slide laterally inwards

whilst the pivot axes 32 move downwards. The holding surfaces 26 then assume a flatter position which in a lowermost position can run at least approximately horizontally. This can be deduced from FIG. 5 and is to be denoted as a release position. Herewith, the vehicle 2 is very flat and can be moved to below the container 16 and to below a placement surface 20. In the release position, the holding surfaces 26 do not essentially project beyond the support surface 12.

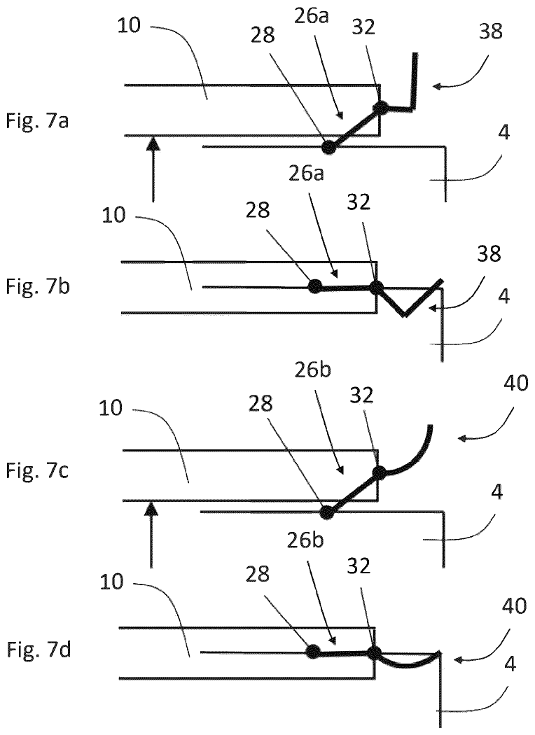

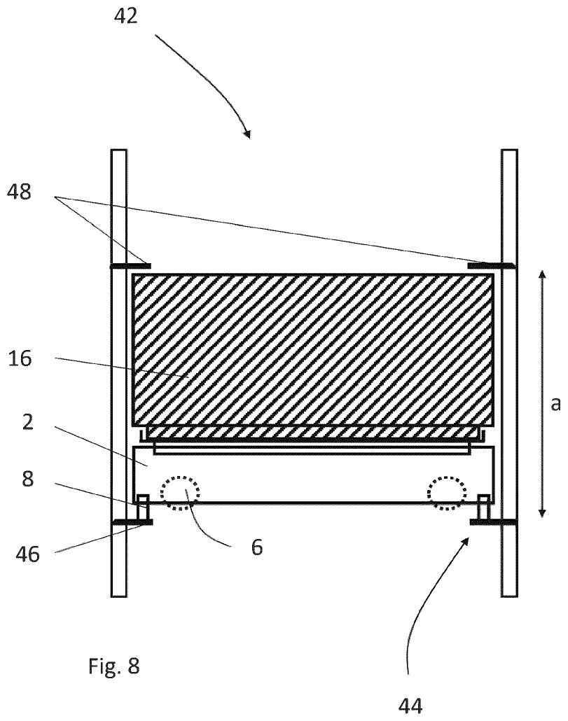

Modifications of the holding surface 26 are shown in FIGS. 7a to 7d. FIGS. 7a and 7b show a holding surface 26a which comprises a region 38 which is away from the support surface 12 and which is bent at an angle to the support surface 12. Herewith, the stack edge 18 can be embraced quite well, wherein despite this a very flat release position can be realized. Otherwise, a region 40 of a holding surface 26b which is away from the support surface 12 and which is arched towards the support surface 12 is shown in FIGS. 7c and 7d. Herewith, a similar advantage as with the angularly bent region 38 is achieved.

FIG. 8 shows a two-dimensional representation of a part of a storage system 42 which is directed onto the vehicle 2 to the rear, wherein the storage system 42 comprises a track arrangement 44 with track rail sections 46. The afore described vehicles 2 can travel on the track arrangement 44 and herein move containers 16 which can be deposited in a storage rack arrangement which is not represented here. The track arrangement 44 comprises inclined sections, above which keep-down devices 48 are arranged. These measured perpendicularly to the respective track rail section 46 which lies there below have a distance a which exceeds a height of the respective vehicle 2 with the container 16 which is located thereon, such that given a vehicle 2 which is situated fully on the track rail section 46 and a container 16 which lies fully on the vehicle 2, the vehicle 2 and the container 16 can be moved without hitting the keep-down device 48. However, if the container 16 should tilt on account of the oblique alignment of the track rail section 46, the edge which lifts up will contact the keep-down device 48, so that the tilting movement is limited. In this embodiment example, the distance between the keep-down devices 48 and an upper side of the container 16 is very low and only a minimal tilting movement is tolerated. However, it is conceivable for tilting movements of up to 20° C. to the upper side or the support surface 12 of the vehicle 2 to be able to be tolerated.

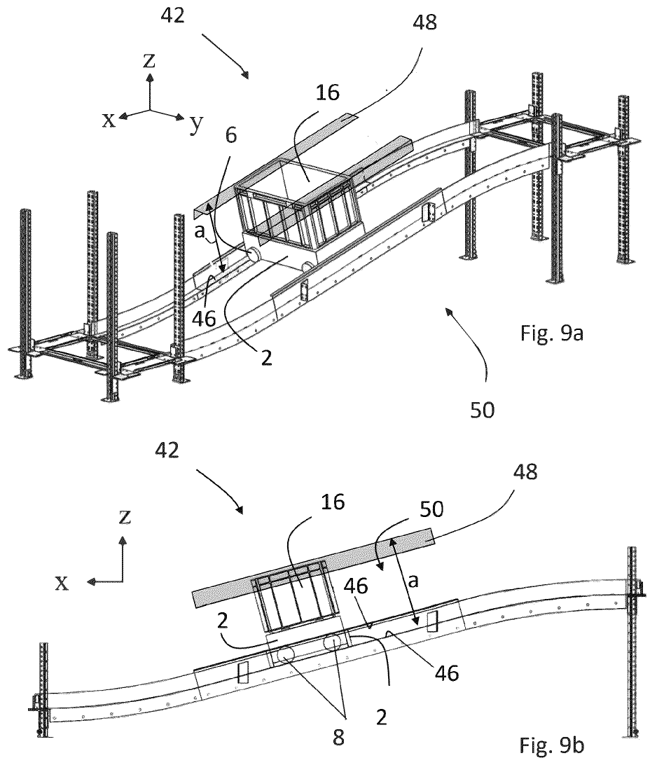

This is shown in further views in FIGS. 9a and 9b. FIG. 9a in a three-dimensional representation shows an inclined section 50 in the track arrangement 44, above which keep-down devices 48 are arranged at both sides in the travel direction, in order to limit a tilting movement of the container 16 given the travel of a vehicle 2. FIG. 9b shows this in a lateral view.

While specific embodiments of the invention have been shown and described in detail to illustrate the application of the principles of the invention, it will be understood that the invention may be embodied otherwise without departing from such principles.

### LIST OF REFERENCE NUMERALS

1 self-driving vehicle (prior art)
2 self-driving vehicle
4 frame
6 first wheel set
8 second wheel set
10 lifting table
12 support surface
14 base surface
16 container
18 stack edge
20 placement surface
22 holding surface
24 holding surface
26, 26a, 26b holding surface
28 inner edge
30 outer edge
32 pivot axis
34 displaceable pivot bearing
36 fixed pivot bearing
38 angled region
40 arched region
42 storage system
44 track arrangement
46 track rail section
48 keep-down device
50 inclined section
α angle
a distance

1. A self-driving vehicle for the automatic storage and retrieval of containers (in a storage rack arrangement, wherein the vehicle comprises:
a frame with a lower side and with an upper side;
a first wheel set for the drive along a first axis;
a second wheel set for the drive along a second axis which runs transversely to the first axis, the first wheel set and the second wheel set being at the lower side;
a liftable and lowerable lifting table with a support surface for carrying a base surface of a container, the liftable and lowerable lifting table being at the upper side; and
a holding device with holding surfaces which are adjacent to the support surface at an edge thereof and which at least partly and at least temporarily project away from the support surface.

2. A self-driving vehicle according to claim 1, wherein an angle between the support surface and the respective holding surfaces lies in a range of 120° to 165°.

3. A self-driving vehicle according to claim 1, wherein at least one of the holding surfaces is mounted in a movable manner and can be brought into a release position and into a holding position, the at least one of the holding surfaces in the holding position projects beyond the support surface and encloses an angle with the support surface of at least 90° and at the most 180°, and the at least one of the holding surfaces in the release position does not essentially project beyond the support surface.

4. A self-driving vehicle according to claim 3, wherein the at least one of the holding surfaces each comprises an outer edge and an inner edge, and the outer edge is liftable with respect to the inner edge for assuming the holding position.

5. A self-driving vehicle according to claim 4, wherein the at least one of the holding surfaces is pivotably connected to the frame at a respective inner edge thereof.

6. A self-driving vehicle according to claim 3, wherein the at least one of the holding surfaces is coupled to the frame and to the lifting table in a movable manner, so that the at least one of the holding surfaces is moved on lifting the lifting table into the holding position and the at least one of the holding surfaces is moved on lowering the lifting table into the release position.

7. A self-driving vehicle according to claim 6, wherein the at least one of the holding surfaces each comprises a pivot axis which lies between the respective inner edge and the outer edge, and the at least one of the holding surfaces is pivotably mounted with the lifting table at the pivot axis.

8. A self-driving vehicle according to claim 6, wherein the at least one of the holding surfaces is pivotably connected to the frame at a respective inner edge thereof and the respective inner edge is arranged on the frame by way of at least one laterally displaceable pivot bearing.

9. A self-driving vehicle according to claim 7, wherein the at least one of the holding surfaces is pivotably mounted on the lifting table by way of at least one laterally displaceable pivot bearing.

10. A self-driving vehicle according to claim 1, further comprising a movement device arranged on the frame, wherein at least one of the holding surfaces is pivotable by way of the movement device.

11. A self-driving vehicle according to claim 1, wherein the holding surfaces are provided on at least two sides of the support surface which are opposite one another, wherein the support surface and the holding surfaces at least temporarily form a trough which widens to the top.

12. A self-driving vehicle according to claim 1, wherein at least one of the holding surfaces at a region which is away from the support surface is angularly bent or arched towards the support surface.

13. A storage system, comprising:
a track arrangement with several track rail sections;
vehicles which are self-driving on the track arrangement, for the automatic storage and retrieval of containers in a storage rack arrangement which can be coupled to the track arrangement, each of the vehicles comprising:
a frame with a lower side and with an upper side;
a first wheel set for the drive along a first axis; and
a second wheel set for the drive along a second axis which runs transversely to the first axis, the first wheel set and the second wheel set being at the lower side;
a liftable and lowerable lifting table with a support surface, the liftable and lowerable lifting table being at the upper side; and
a holding device with holding surfaces which are adjacent to the support surface at an edge thereof and which at least partly and at least temporarily project away from the support surface; and
containers which can be placed onto the support surface of the self-driving vehicle and which can be deposited in the storage rack arrangement.

14. A storage system according to claim 13, further comprising at least one keep-down device which is arranged at least partly above at least one inclined section of at least one of the track rail sections, wherein a distance between the track rail section and the at least one keep-down device measured perpendicularly to the at least one track rail section exceeds a height of the respective vehicle with a container located thereon, only to the extent that the respective container can tilt to the support surface about an angle of at the most 20° without hitting the respective keep-down device.

15. A storage system according to claim 14, wherein the track arrangement comprises track rail sections in different levels, wherein the at least one keep-down device is formed by a lower side of a track rail section of a level which runs above the at least one track rail section.
